(19) United States
(12) Patent Application Publication
(10) Pub. No.: US 2012/0011640 A1
(43) Pub. Date: Jan. 19, 2012

(54) Releasable Clips

(75) Inventor: Quang L. Duong, Stockbridge, GA (US)

(73) Assignee: YKK Corporation of America, Marietta, GA (US)

(21) Appl. No.: 12/835,215

(22) Filed: Jul. 13, 2010

(51) Int. Cl. A42B 1/08; F16B 2/20

(52) U.S. Cl. 2/424; 24/457

(57) ABSTRACT

Clips for securing a face mask to an article of head gear, and for releasing the face mask without the need for any special tools or equipment. In certain embodiments, the clip may comprise a base and a retaining member that is pivotably coupled to the base. When the retaining member is engaged with the base, structure on the base prevents the retaining member from pivoting open, thus securing the face mask within the clip. To disengage the retaining member (and release the face mask from the clip), a user may squeeze or flex a portion of the base, which causes the retaining member to disengage and pivot open.

### FIELD OF THE INVENTION

The following invention relates to clips to securely retain objects in place and to release the clips without the need for tools or other instruments.

### BACKGROUND OF THE INVENTION

A user might wear protective head gear that includes a face mask attached to the head gear. For example, head gear designed for various sporting events (such as football helmets, catcher's masks in baseball, or hockey masks) may have a face mask that covers and protects the user's face. Head gear designed for use by police officers, fire fighters, or armed forces personnel may also include face masks. The body of such head gear is typically made of a hard, solid material (such as plastic) and covers the top, sides, and back of the user's head. Typically, the body has an opening adjacent to the user's neck that allows the user to take the head gear on and off. The body may also have another opening that exposes the user's face, which may be at least partially covered by a face mask made of wires or bars. Face masks secured to head gear may present several problems.

First, face masks are typically secured to the body of head gear with a strap, clip, or other mechanical fastener. Such mechanical fasteners may be prone to failure if the user sustains a blow to the head that is received by the head gear. Thus, the mechanical fastener may break, which may cause the face mask to separate from the body of the head gear, subjecting the user to injury.

Second, it may not be easy or safe to disable known mechanical fasteners in order to remove the face mask in the case of an emergency. In most instances, the user may remove his or her head gear simply by grasping and pulling the body from the user's head. But in other instances, it may not be possible to remove the head gear as such. For example, in an emergency when a user is injured it may be necessary to keep the user's head and neck stabilized. Thus, it may not be safe to grasp and pull the body of the head gear from the user's head.

Systems have been developed to allow face masks to be removed from the head gear, thus avoiding the need to pull the body of the head gear from the user's head. In some systems, a mechanical fastener (such as a strap) is provided that loops around a portion of the face mask and is fastened to the body of the head gear with screws. To remove the face mask, a screw driver or other tool must be used to unfasten the screw, or a knife must be used to cut the strap. But such systems are problematic in that it takes time to unfasten the screws or cut the straps. Such systems also require tools (such as screw drivers, knives, or scissors) that might be difficult to locate or to use in an emergency situation. Finally, such systems require application of force (for example, unfastening a screw or cutting through a strap) that may cause the user's head to move, which is undesirable if the user's head must be stabilized.

Thus, there is a need for a system that may be used to quickly and easily remove a face mask from the head gear worn by a user.

Specifically, there is a need to reduce the amount of time it takes to remove a face mask from the head gear.

There is a need to reduce the number of tools required to remove a face mask from the head gear.

There is also a need to reduce the number of movements required to remove a face mask from the head gear.

There is also a need to provide systems for securing face masks that are resistant against forces that impact the head gear.

### SUMMARY OF THE INVENTION

Certain embodiments provide a clip for securing a face mask to the body of an article of head gear, and for releasing the face mask without the need for any special tools or equipment. In certain embodiments, the clip comprises a base and a retaining member that is pivotably coupled to the base. When the retaining member is engaged with the base, a pair of engaging members on the base prevent the retaining member from pivoting open, thus securing the face mask within the clip. One example of an engaging member is an overhang that extends into the interior space formed by the sidewalls of the base. To disengage the retaining member (and thereby remove the face mask from the clip), a user may squeeze or flex inward a portion of the base, which causes the retaining member to disengage and pivot open.

Certain embodiments thus reduce the amount of time it takes to remove a face mask from the head gear. Additionally, unlike in known systems that require special tools to remove a face mask, embodiments described herein may only require a user's fingers to squeeze or flex the base, thus releasing the face mask from the clip.

### BRIEF DESCRIPTION OF THE DRAWINGS

A full and enabling disclosure including the best mode of practicing the appended claims and directed to one of ordinary skill in the art is set forth more particularly in the remainder of the specification. The specification makes reference to the following appended figures, in which use of like reference numerals in different features is intended to illustrate like or analogous components.

FIG. 1 is an illustration of a user wearing head gear with a clip.

FIG. 2 is a perspective view of a clip coupled to the body of head gear and retaining the face mask of the head gear.

FIG. 3 is a perspective view of a retaining member of a clip.

FIG. 4 is a side plan view of the retaining member of FIG. 3.

FIG. 5 is a front plan view of the retaining member of FIG. 4.

FIG. 6 is a perspective view of a base of a clip.

FIG. 7 is a side plan view of the base of FIG. 6.

FIG. 8 is a detailed perspective view of the clip of FIG. 2.

FIG. 9 is a perspective view of another clip, shown with the release wings of the base partially engaged.

FIG. 10 is a detailed perspective view of the clip of FIG. 9.

FIG. 11 is a perspective view of a clip coupled to the body of head gear and releasing the face mask of the head gear.

FIG. 12 is a perspective view of another clip.

FIG. 13 is a side plan view of the clip of FIG. 12.

FIG. 14 is a perspective view of another base of a clip.

FIGS. 15A and 15B are cross-sectional views of the base of FIG. 14, taken along the line FIG. 15-FIG. 15.

### DETAILED DESCRIPTION

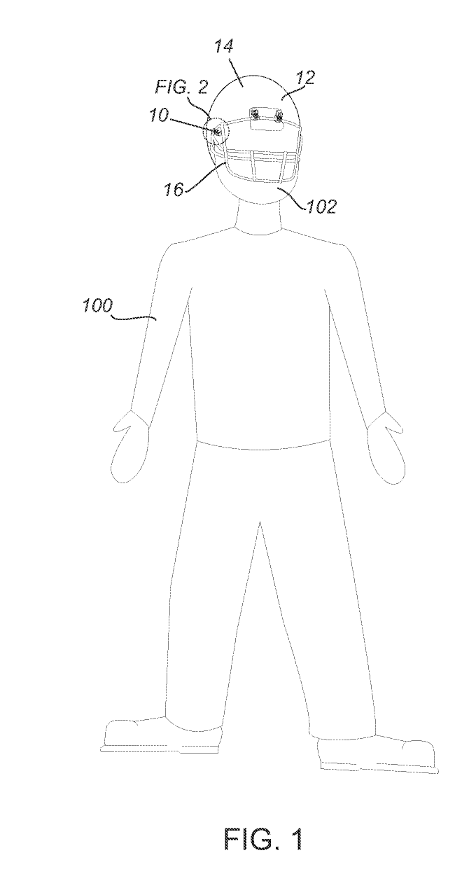

FIG. 1 shows a user 100 wearing head gear 12 on the head 102 of the user 100. The head gear 12 includes a body 14, a face mask 16, and a clip 10. As used herein, head gear 12 is non-limiting and includes head gear 12 designed for any sporting events (such as football, baseball, softball, hockey, lacrosse, cricket, horseback riding, polo, water skiing, snow skiing, BMX racing, skateboarding, etc.) or head gear 12 designed for other uses such as by police officers, fire fighters, or other armed forces. Any type of head gear 12 having a face mask 16 secured to a body 14 is within the scope of this invention. The particular material or shape of the body 14 and/or face mask 16 is also non-limiting. For example, either the body 14 or the face mask 16 may be made of any type of plastic, metal, or composite.

Furthermore, although the embodiments described herein are for use with head gear 12, the same concepts could be used in other applications where it is desired to retain a first object on a second object, and to quickly and easily remove the first object from the second. For example, embodiments described herein could be used to retain wires, cables, shelving, or drawers to surfaces such as a wall or a piece of furniture. Thus, embodiments generally encompass any application where is desired to retain, and quickly and easily remove, a first object and a second object.

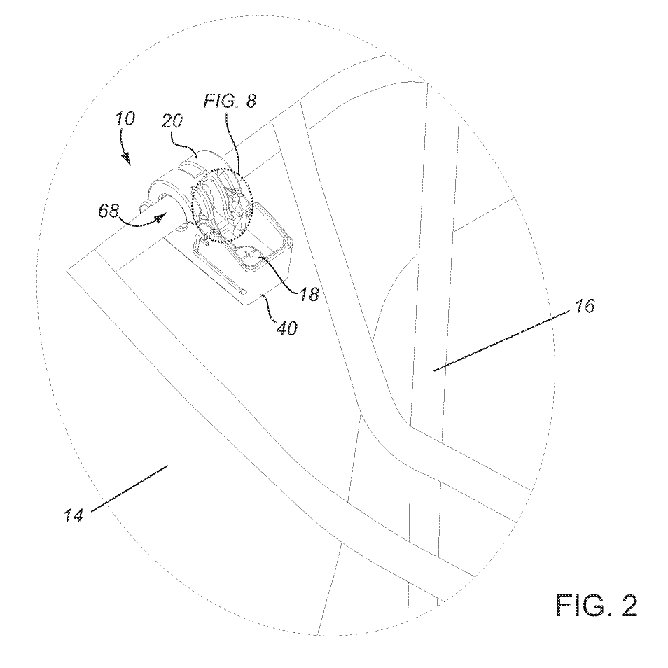

FIG. 2 is a detailed view of the head gear 12 shown in FIG. 1, comprising a body 14, a face mask 16, and a clip 10. The face mask 16 may be made of multiple wires. (One of skill in the art may alternatively refer to wires as bars or rods.) The number, shape, and arrangement of the wires that comprise the face mask 16 are non-limiting. There may be more than one clip 10 provided on the head gear 12, and the clips 10 may be provided in any arrangement or configuration on the head gear 12. In some embodiments, the face mask 16 may be secured using clips 10 described herein along with other known clips. The clip 10 may be secured to the body 14 of head gear 12 by any method known to one of skill in the art. In FIG. 2, a fastener 18 is used to secure the clip 10 through a mounting aperture 44 provided in the base 40 of the clip 10. In other embodiments, the clip 10 may be secured to body 14 with adhesive, welding, clips, dove-tails, nails, or other methods.

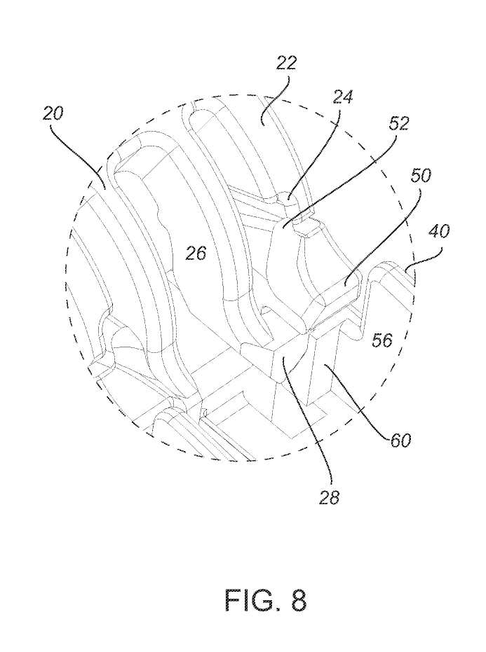

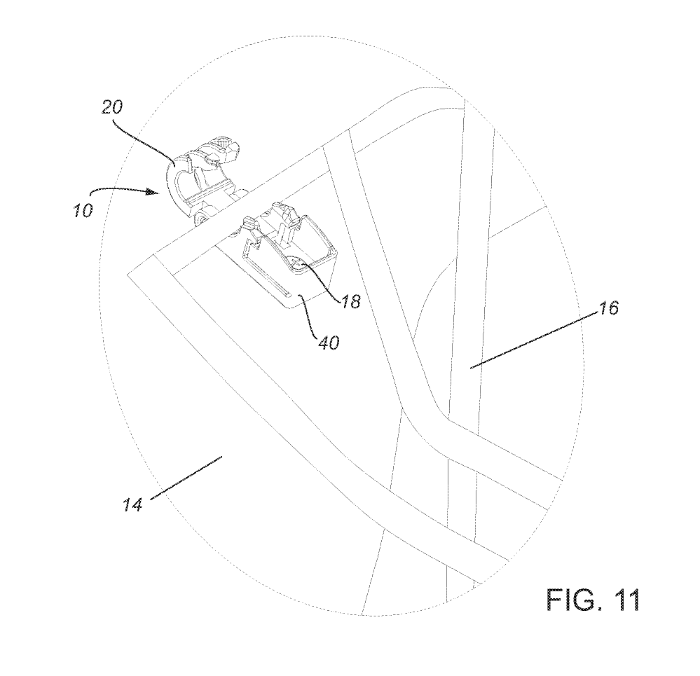

As shown in FIG. 2, the clip 10 may include a retaining member 20 and a base 40. The retaining member 20 in FIGS. 2 and 8 is engaged such that the body 30 of retaining member 20 (which includes side arms 22 and prongs 26), together with a curved edge 54 of the base 40, define a receiving aperture 68. In this engaged position, the face mask 16 is secured within the receiving aperture 68 and thus, the face mask 16 is retained on the body 14 of the head gear 12. The retaining member 20 shown in FIG. 11 is disengaged such that the face mask 16 can be removed from the clip 10.

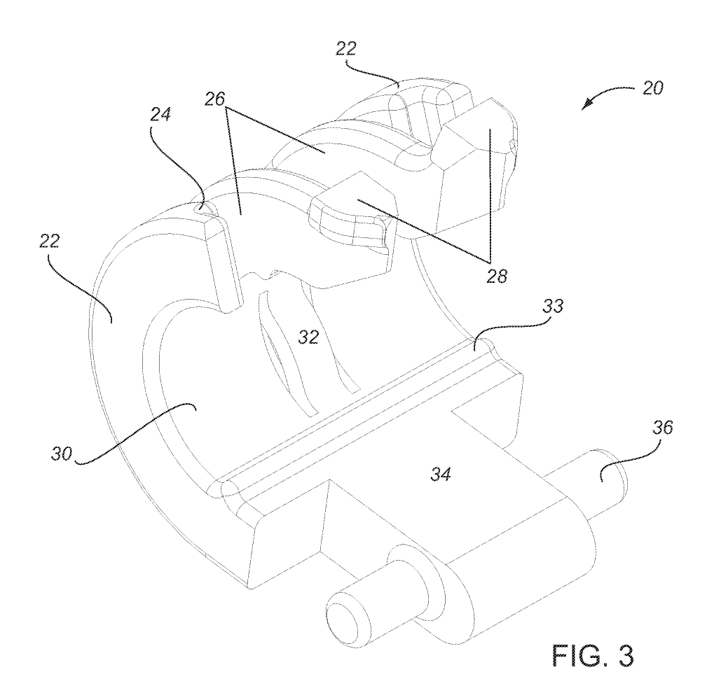

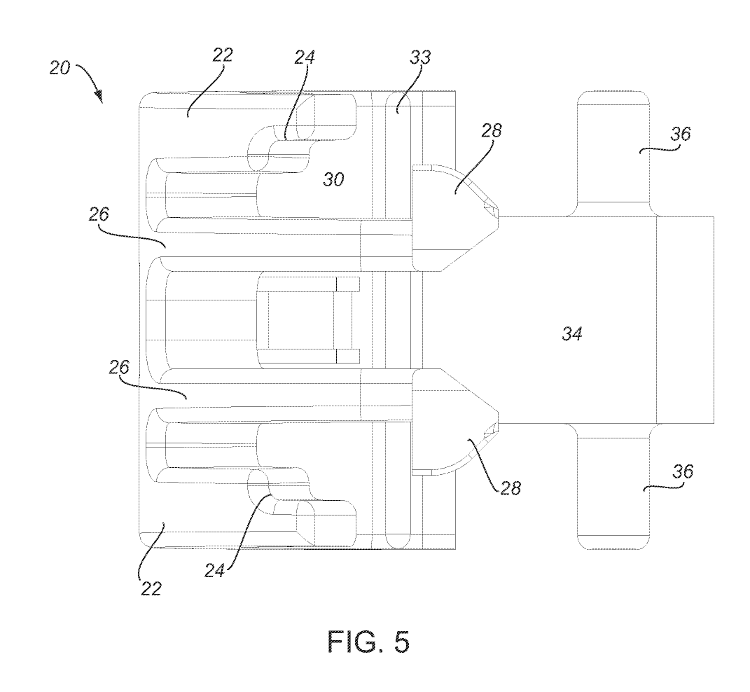

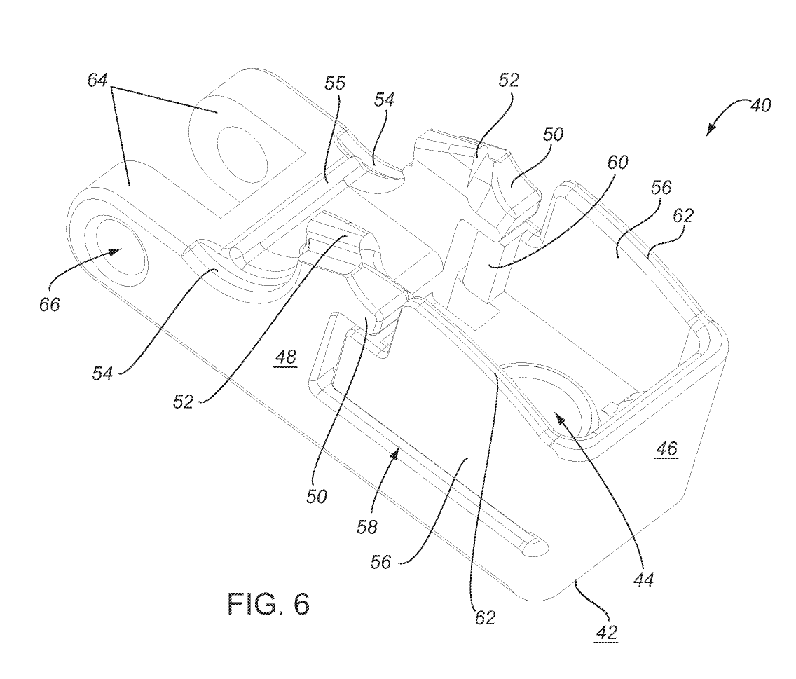

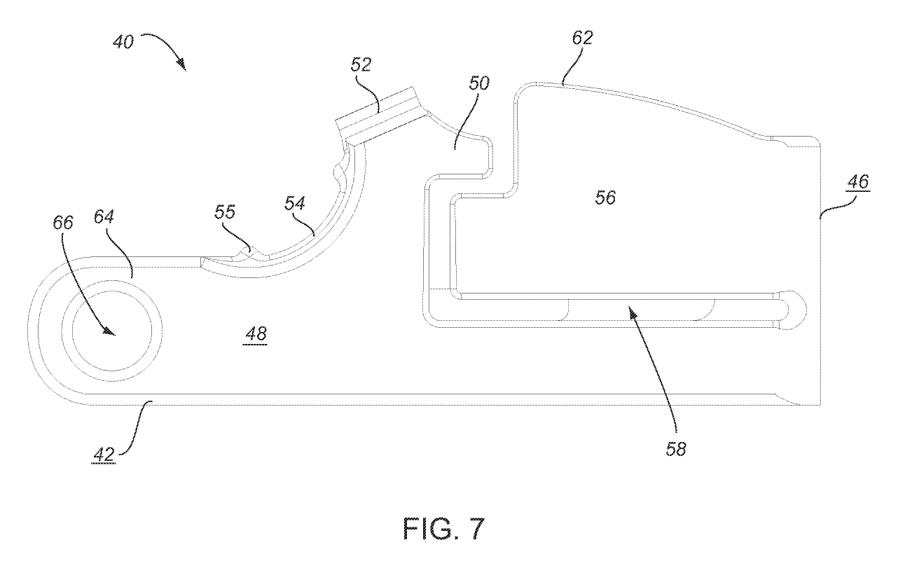

A detailed view of a retaining member 20 is shown in FIGS. 3-5. In certain embodiments the side arms 22 include a step 24 and the prongs 26 include extensions 28. A detailed view of base 40 is shown in FIGS. 6 and 7. In certain embodiments the base 40 includes sidewalls 48, which include an overhang 50 separated from a release member 56 by a channel 58. In other words, the sidewall 48 includes a channel 58 that separates the overhang 50 from the release member 56. As described below, the overhang 50 engages with the extension 28 of the retaining member 20 to secure the retaining member 20 to the base 40; and thus, the overhang 50 and the extension 28 are non-limiting examples of “engaging members” for the base 40 and the retaining member 20, respectively. In certain embodiments the overhang 50 is provided with a step 52, and the step 52 of overhang 50 may engage with a corresponding step 24 on side arm 22 (of the retaining member 20). In certain embodiments the release member 56 is provided with a projection 60, and the projection 60 of release member 56 may engage with the extension 28 on prong 26.

To engage the retaining member 20, the retaining member 20 pivots towards the base 40. The prongs 26 move between the sidewalls 48 of the base 40. As the extensions 28 of the prongs 26 contact the sidewalls 48, the prongs 26 squeeze together. The prongs 26 continue to squeeze together until the extensions 28 move below the overhang 50, at which point the sidewalls 48 stop squeezing the prongs 26 together. The prongs 26 expand and return to their original position. When the prongs 26 expand, the extensions 28 fit underneath the overhang 50 of the sidewalls 48, as shown in FIG. 8. The retaining member 20 is prevented from moving away from the base 40 due to the contact between the overhang 50 and the extensions 28 of the prongs 26. Thus, the overhang 50 and the extensions 28 are non-limiting examples of “engaging members” for the base 40 and the retaining member 20, respectively. In certain embodiments, there may be provided additional structure to ensure sufficient contact and engagement between the overhang 50 and/or the extensions 28. For example, there may be provided a dimple on overhang 50 that mates with a recess on extension 28 when the retaining member 20 is in the engaged position. (Alternatively, the dimple may be provided on extension 28 and the recess may be provided on overhang 50.) The dimple and recess are non-limiting, and other embodiments may include other structure that mate with each other. When the retaining member 20 is engaged, the body 30 of the retaining member 20 (which includes side arms 22 and prongs 26) and the curved edge 54 of the base 40 define the receiving aperture 68 that receives the face mask 16.

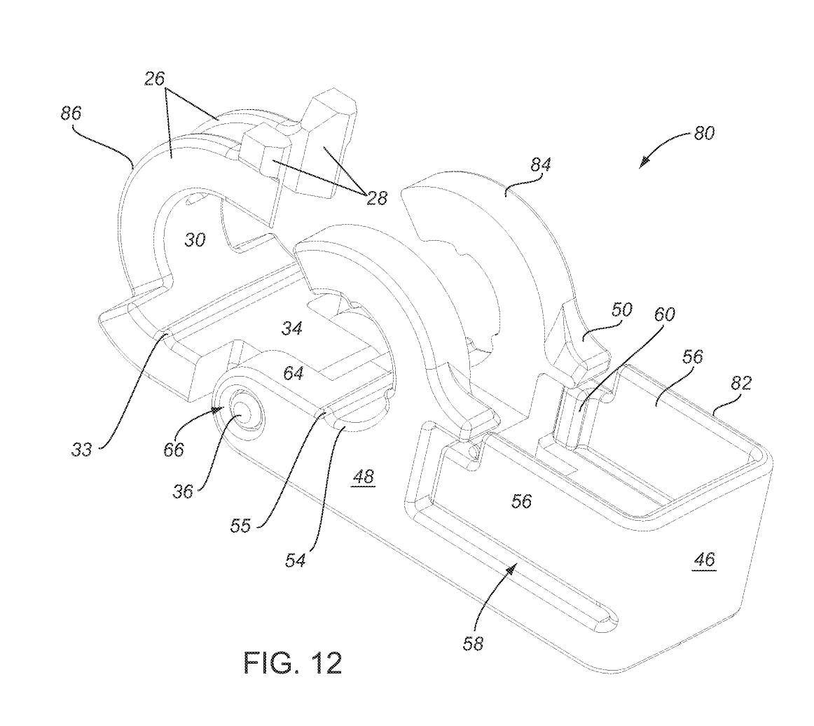

In certain embodiments the inner edges of the body 30 of retaining member 20 and the curved edge 54 of the base 40 are generally curved. Thus, the receiving aperture 68 has a similar shape to that of the round wires that comprise the face mask 16. Alternatively, if the face mask 16 were made of wires having a non-circular shape (such as square), then the body 30 of retaining member 20 and/or the curved edge 54 of base 40 may be provided with a corresponding shape (thus, the body 30 and/or curved edge 54 may be square, for example). As shown in FIG. 12, there may be protrusions 33 extending across the retaining member 20 and/or protrusions 55 extending across curved edge 54 of the base 40. There may be any number of protrusions 33, 55 provided in any arrangement or configuration. For example, the protrusions 33, 55 need not extend continuously across the retaining member 20 or base 40 (respectively), but can rather extend across only a portion. When the retaining member 20 is engaged, the protrusions 33, 55 provide for a more secure fit of the face mask 16 within the receiving aperture 68. As described in more detail below, the body 30 of retaining member 20 may optionally be provided with a member 32 which contacts and applies force to the face mask 16 when it is secured within the receiving aperture 68.

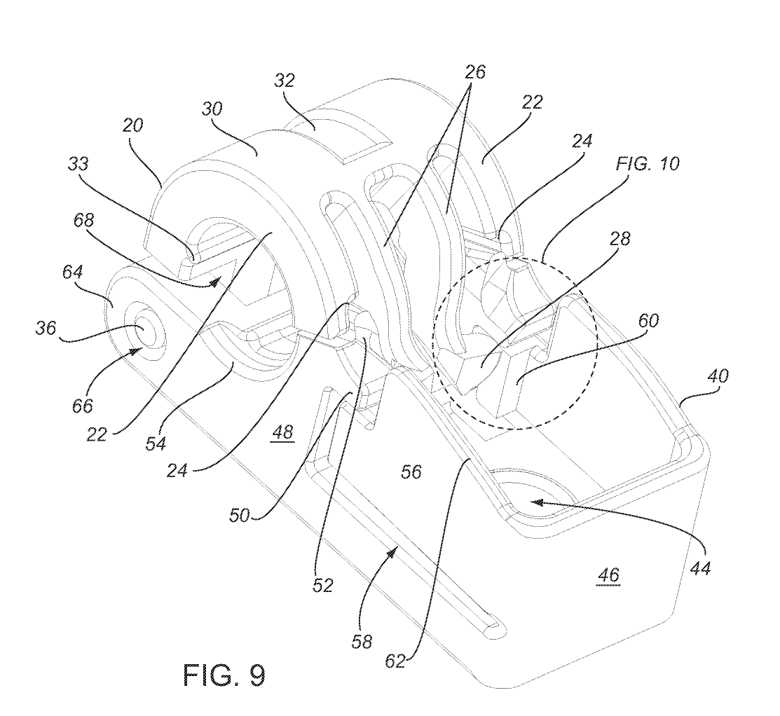

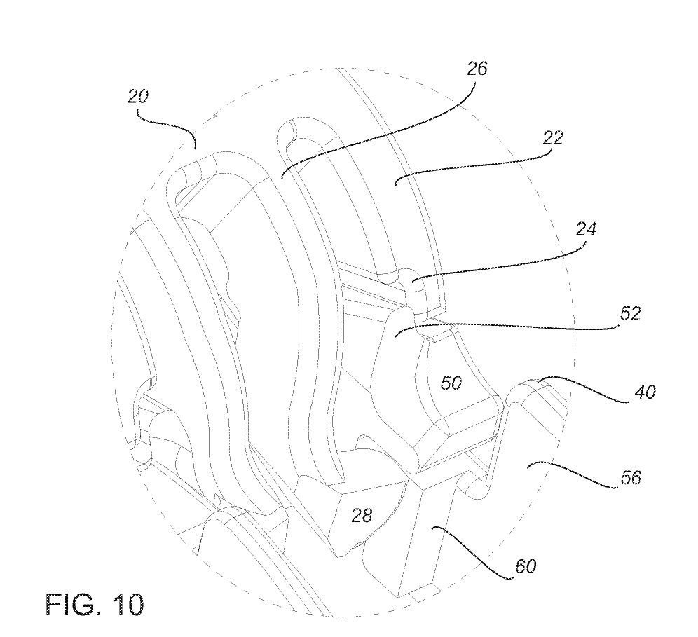

The retaining member 20 shown in FIG. 11 is disengaged such that the face mask 16 is removable from the clip 10. As shown in FIGS. 9 and 10, to disengage the retaining member 20, a portion of the release members 56 of the base 40 are flexed inward towards the prongs 26 of the retaining member 20. The release members 56 are free to flex relative to the rest of the base 40 because they are separated by channels 58. When the release members 56 flex inward, the projections 60 on the release members 56 contact and press against the extensions 28 on the prongs 26. Such contact squeezes the prongs 26 together. The extensions 28 of the prongs 26 may thus move out from underneath the overhang 50 of the base 40, allowing the prongs 26 to move freely up the sidewalls 48 of the base 40. The retaining member 20 is thus disengaged from the base 40, which allows the face mask 16 to be released from the clip 10.

Thus, embodiments of clips 10 described herein may be released by flexing a portion of the release members 56 inward. (Specifically, the portion of the release member 56 distal the end wall 46 may be flexed inward.) A user 100 (or another person, such as a care-taker who is tending to the user 100) may flex the release members 56 simply by squeezing them with their fingers. If desired, the release members 56 may be provided with a curved upper portion 62 to make it easier to grip and squeeze the release members 56. In other embodiments, the upper portion 62 is not curved, but is merely elevated above the sidewall 48 such that the upper portion 62 is easier to grip. Thus, no special tools or equipment are needed to release the clips 10. Additionally, the clips 10 may be released quickly (by squeezing the release members 56) and with minimal movement that might be passed along to the user 100.

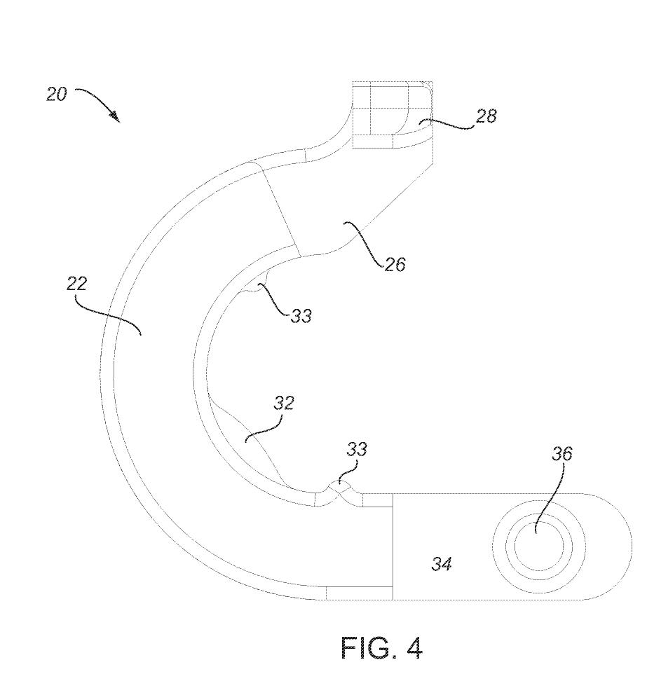

Additional speed (and ease of movement) in releasing the clip 10 may be provided by member 32, which may optionally be provided on the body 30 of retaining member 20. When the retaining member 20 is engaged, the member 32 contacts and applies force to the face mask 16. When the retaining member 20 is disengaged, the force applied by the member 32 pushes the retaining member 20 open, such that the retaining member 20 opens more quickly. Thus, additional benefits may be provided by a member 32 in releasing the clip 10. In the embodiments shown in FIGS. 3 and 4, the member 32 is in the shape of a leaf spring that contacts and flexes against the face mask 16. In other embodiments the member 32 may be provided as another type of spring, or another device that applies force to the face mask 16.

Embodiments described herein also resist damaging forces that may impact the head gear 12 and cause the retaining member 20 to become disengaged from the base 40. For example, side arms 22 may be provided on the retaining member 20. The step 24 of side arm 22 may engage with the corresponding step 52 on the overhang 50. If a force impacts laterally on the clip 10 and strikes a side arm 22, the side arm 22 acts as a barrier such that the force does not impact the prong 26 (possibly disengaging the retaining member 20). The corresponding steps 24, 52 of the side arm 22 and overhang 50 engage such that the side arm 22 does not flex and strike the prong 26. Additionally, the corresponding steps 24, 52 provide resistance against any torsion acting on the clip 10. As another example, in certain embodiments the retaining member 20 may not be disengaged unless both of the release members 56 (on opposite sides of the base 40) are flexed. Thus, if a force impacts laterally on the clip 10 and strikes one release member 56 (such that the release member 56 flexes), the retaining member 20 will not be disengaged, because the opposite release member 56 is not impacted by force and is not flexed.

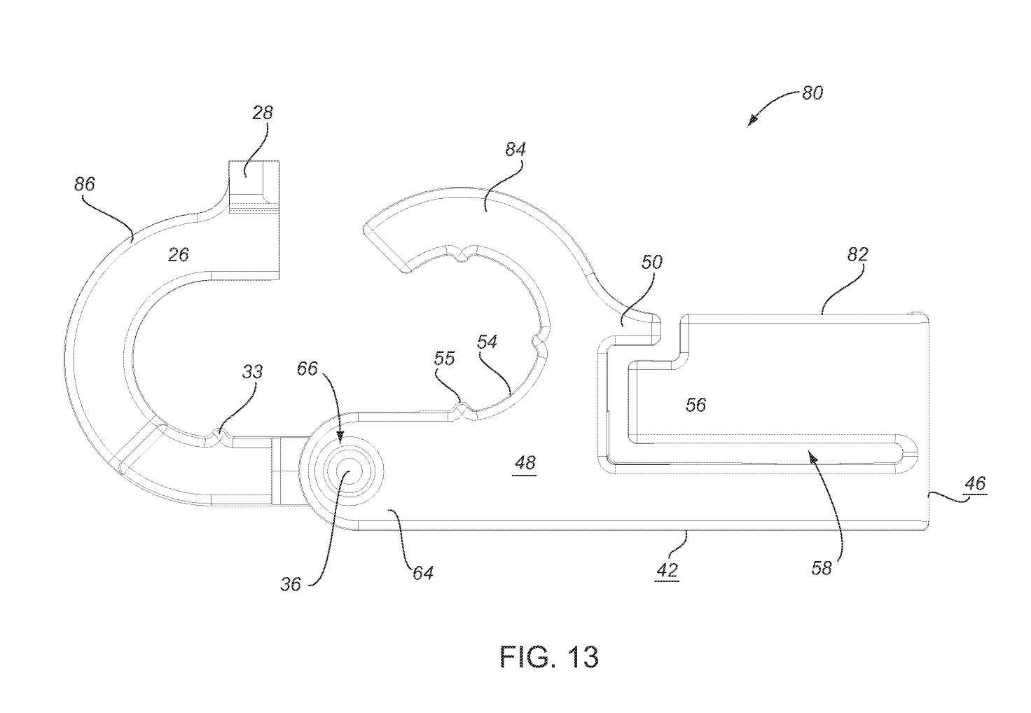

Another clip 80, including base 82 and retaining member 86, is shown in FIGS. 12 and 13. Here, the overhang portion 50 of base 82 is extended to form at least one prong 84. The retaining member 86 includes prongs 26, similar to those described above with respect to retaining member 20, but do not include the side arms. When the retaining member 86 is engaged, the prongs 26 move down and are squeezed between the prongs 84 of the base 82. The extensions 28 of prongs 26 engage with the overhang 50 in the same manner as described above. When engaged, the receiving aperture 68 is defined by prongs 26 of the retaining member 86 and by the curved edge 54 and the prongs 84 of the base 82. In still other embodiments, there may be only one prong 26, 84 on either or both of the retaining member 86 and the base 82.

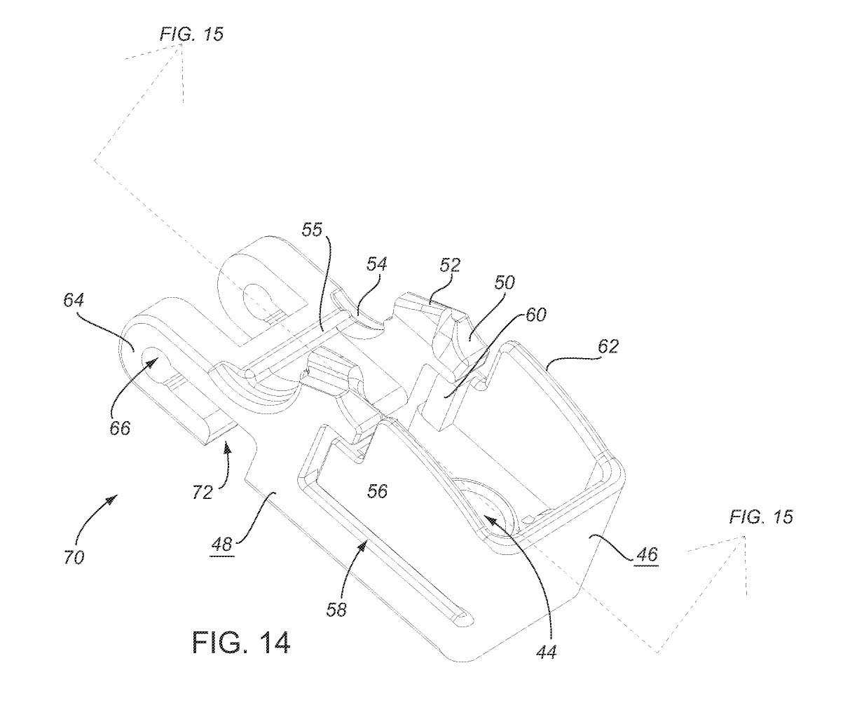

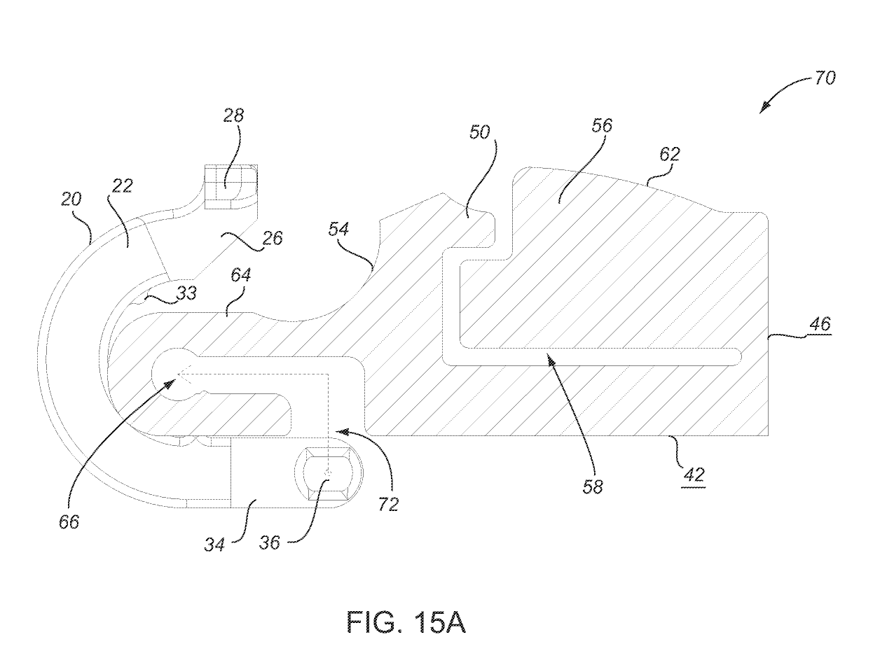

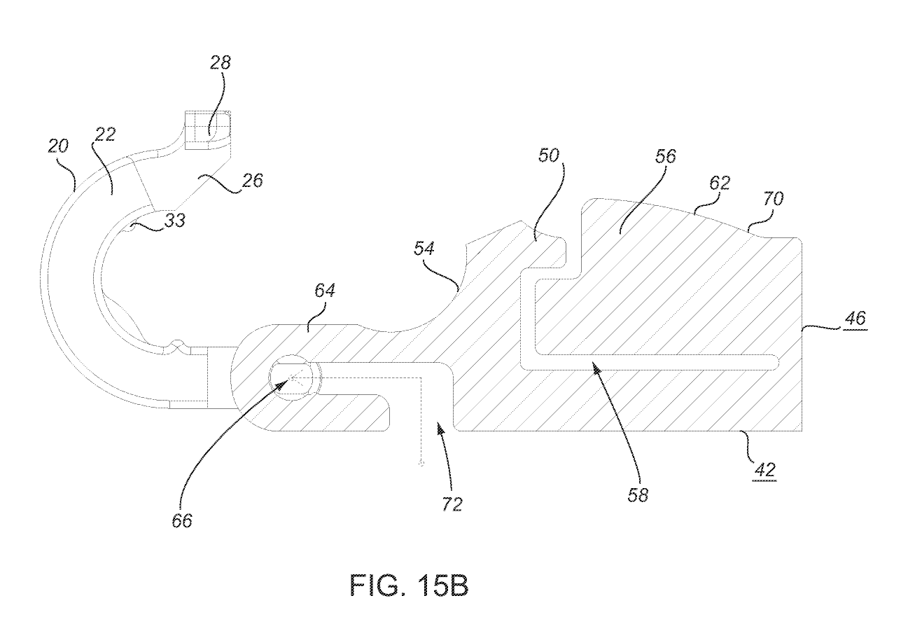

The retaining member 20 may be coupled to the base 40 in any number of ways. In one embodiment the retaining member 20 and the base 40 are injection molded, using the same mold, such that the retaining member 20 and the base 40 may be formed in one injection molding process. Thus, the coupling pegs 36 provided on the lower portion 34 of retaining member 20 are molded within apertures 66 of the coupling tabs 64 on the base 40. In another embodiment, the retaining member 20 and the base 40 are formed separately and may be coupled with a pin, peg, post, or other structure received through apertures 66 of the coupling tabs 64. Another embodiment of a base 70 is illustrated in FIGS. 14, 15A, and 15B. In this embodiment, base 70 includes an “L-shaped” coupling channel 72 that receives the coupling pegs 36 of the retaining member 20. As shown FIG. 15A, the coupling pegs 36 may be received in the coupling channel 72 and moved in the direction of the arrow until the coupling peg 36 is received in the aperture 66 (FIG. 15B).

In some instances the retaining member 20 may become damaged and need to be replaced. In the embodiments in FIGS. 14, 15A, and 15B, the retaining member 20 may be slid out from the coupling channel 72 to thus replace the retaining member 20. In other embodiments, the retaining member 20 may be de-coupled by removing the pin or coupling pegs 36 from the base 40. In general then, the structure for coupling the retaining member 20 and the base 40 is non-limiting.

As shown in FIG. 6, the end wall 46 and the release members 56 surround a mounting aperture 44 that is defined in the lower surface 42 of the base 40. As shown in FIGS. 2 and 11, the mounting aperture 44 may receive a fastener 18 for securing the clip 10 to the body 14 of the head gear 12. The fastener 18 (specifically, removal of the fastener 18) is not necessary to engage or disengage the retaining member 20, which eliminates the need for special tools (screw drivers or knives) to release the face mask 16. Besides fasteners 18, the clip 10 may be secured to body 14 with other methods, including but not limited to adhesive, welding, clips, dove-tails, or nails. The retaining member 20 may be engaged (and hence, the face mask 16 secured within the receiving aperture 68) either before or after the clip 10 is secured to the body 14 of the head gear 12. If one of the clips 10 becomes damaged, then it can be removed from the head gear 12 and replaced with another clip 10.

The components of the clips 10 descried herein (including either of the retaining member 20 or base 40) may be constructed from a variety of materials, including but not limited to polyurethane, nylon, acetal, or an impact modified polyacetal resin, such as TPOM. The use of such lightweight materials reduce the weight of the clip 10. If desired, the material may be reinforced with fibers, and may include additional additives such as fire retardants. The retaining member 20 and base 40 may be made from the same material, or different materials. As discussed above, the retaining member 20 and base 40 may be manufactured using injection molding (either in one molding step, or separate molding steps to form each component). In addition to injection molding, the components of the clip 10 may be machined with a lathe or other cutting tool.

The foregoing is provided for purposes of illustration and disclosure of embodiments of the invention. It will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

1. A clip comprising:
a base comprising a first pair of engaging members and a pair of release members, wherein at least a portion of the release members are flexible; and
a retaining member coupled to the base and comprising a pair of prongs, wherein the prongs comprise a second pair of engaging members,
wherein the retaining member is moveable between an engaged position and a disengaged position, and
wherein, when the retaining member is in the engaged position, the first pair of engaging members engage with the second pair of the engaging members to secure the retaining member to the base, and
wherein, when the retaining member is in the disengaged position, the retaining member is released from the base by flexing at least a portion of the release members to thereby disengage the second pair of engaging members from the first pair of engaging members.

2. A clip as in claim 1, wherein the base further comprises a lower surface, an end wall adjacent to the lower surface, and pair of sidewalls opposite one another and adjacent to the end wall.

3. A clip as in claim 2, wherein the first pair of engaging members comprise a portion of the pair of sidewalls.

4. A clip as in claim 2, wherein the pair of release members comprise a portion of the pair of sidewalls and are defined, in part, by a pair of channels on the pair of sidewalls.

5. A clip as in claim 4, wherein a first end of a release member is attached to the end wall, and a second end of the release member is flexible.

6. A clip as in claim 2, wherein the lower surface of the base defines a coupling channel, and wherein the retaining member further comprises at least one peg that is received within the coupling channel to thereby couple the retaining member to the base.

7. A clip comprising:
a base comprising a pair of sidewalls opposite one another, wherein the pair of sidewalls comprise a first pair of engaging members and a pair of release members; and
a retaining member comprising a first end coupled to the base and a second end comprising a second pair of engaging members,
wherein the retaining member is pivotable about the first end between a first position and a second position, and
wherein, when the retaining member is in the first position, the first pair of engaging members engage with the second pair of the engaging members to thereby secure the second end of the retaining member to the base, and
wherein, when the retaining member is in the second position, the second end of the retaining member is released from the base by causing at least a portion of the release members to apply a force to the second pair of engaging members to thereby disengage the second pair of engaging members from the first pair of engaging members.

8. A clip as in claim 7, wherein the base further comprises at least one aperture and the retaining member further comprises at least one peg within the aperture to couple the retaining member to the base.

9. A clip as in claim 7, wherein the pair of release members comprise a pair of projections, and the projections apply a force to the second pair of engaging members.

10. A clip as in claim 7, wherein the second end of the retaining member further comprises a pair of prongs, and wherein the prongs comprise the second pair of engaging members.

11. A clip as in claim 7, wherein the second end of the retaining member further comprises at least one side arm, and wherein the at least one side arm contacts a portion of a sidewall of the base when the retaining member is in the second position.

12. A clip as in claim 11, wherein the at least one side arm further comprises at least one step and the sidewall further comprises at least one step, and wherein the step of the side arm contacts the step of the sidewall when the retaining member is in the second position.

13. An assembly comprising:
a first object;
a clip comprising:
a base coupled to the first object and comprising a first pair of engaging members and a pair of release members; and
a retaining member comprising a first end coupled to the base and a second end comprising a second pair of engaging members; and
a second object received within the clip,
wherein the retaining member is pivotable about the first end between a first position and a second position, and
wherein, when the retaining member is in the first position, the first pair of engaging members engage with the second pair of the engaging members to thereby secure the second end of the retaining member to the base and to secure the second object within the clip, and
wherein, when the retaining member is in the second position, the second end of the retaining member is released from the base by causing at least a portion of the release members to apply a force to the second pair of engaging members to thereby disengage the second pair of engaging members from the first pair of engaging members.

14. An assembly as in claim 13, wherein the first object comprises a body of an article of head gear and the second object comprises at least a portion of a face mask of the head gear.

15. An assembly as in claim 13, wherein the assembly further comprises a plurality of clips.

16. An assembly as in claim 13, wherein the base further comprises a lower surface that defines a mounting aperture to receive a fastener that couples the base to the first object.

17. An assembly as in claim 13, wherein, when the retaining member is in the first position, the second object is secured to the first object, and wherein, when the retaining member is in the second position, the second object is removable from the first object.

18. An assembly as in claim 13, wherein the base further comprises an edge, and wherein, when the retaining member is in the first position, the edge and the retaining member define a receiving aperture to receive the second object.

19. An assembly as in claim 18, wherein at least one of the edge or the retaining member define protrusions that extend into at least a portion of the receiving aperture.

20. An assembly as in claim 13, wherein the retaining member further comprises a body between the first end and the second end, and wherein the body comprises a member that applies force to the second object when the retaining member is in the first position.
